(19) United States
(12) Patent Application Publication
(10) Pub. No.: US 2018/0247306 A1
(43) Pub. Date: Aug. 30, 2018

(54) SYSTEMS AND METHODS FOR RULE-BASED PAYMENT CARD MANAGEMENT USING TOKENS

(71) Applicant: Passport Technology Inc., Las Vegas, NV (US)

(72) Inventors: Michael Scott Dowty, Las Vegas, NV (US); Kurt Sullivan, La Mesa, CA (US)

(21) Appl. No.: 15/442,540

(22) Filed: Feb. 24, 2017

(51) Int. Cl. G06Q 20/38; G06Q 20/40; G06Q 20/20

(52) U.S. Cl. CPC G06Q 20/38215; G06Q 2220/00; G06Q 20/202; G06Q 20/4012

(57) ABSTRACT

A system includes a point of sale terminal that initiates a first transaction without a transaction amount for a user. A pin entry device receives an account number of a credit card or a debit card used by the user. An application database server receives a first cryptographic token from a token provider. The first cryptographic token corresponds to the account number and is used in place of the account number. The first cryptographic token is used as a database lookup key to identify any transaction rules to be associated with the first transaction. The application database server receives a confirmation message authorizing the first transaction, and transmits the transaction rules and confirmation message to the point of sale terminal. The point of sale terminal initiates a second transaction for a transaction amount in response to the receipt of the transaction rules and the confirmation message.

### FIELD OF THE DISCLOSURE

The present disclosure relates generally to cryptographic tokens, and more specifically, to a system and method for using tokens to manage rules for payment card transactions.

### BACKGROUND

In the payment card industry, credit and debit card transactions are routinely received and processed by payment processing entities or banks (sometimes referred to as acquiring banks) and by the banks that issue the credit or debit cards to customers (referred to as card issuing banks). For example, customers may desire to pay for a retail transaction at a merchant using a credit card. The acquiring bank associated with the merchant and the card issuing bank associated with the customer may authorize the transaction. In a similar manner, a customer may desire to withdraw money from a banking account using a debit card. The acquiring bank associated with an automated teller machine (ATM) used by the customer and the card issuing bank associated with the customer may authorize the withdrawal.

However, in some establishments, access to customers' credit or debit accounts may be restricted or subject to additional regulatory requirements. For example, in gaming establishments such as casinos, customers may not be authorized to withdraw funds to play casino games using a credit card. In addition, casinos may desire to prevent certain customers from wagering on games within the casino and may desire to prevent problem gamblers from wagering more than is appropriate.

The present disclosure is aimed at solving one or more of the problems identified above.

### SUMMARY

In one embodiment, a system includes a point of sale terminal configured to initiate a first transaction for a user, wherein the first transaction does not include a transaction amount. The system also includes a pin entry device coupled to the point of sale terminal. The pin entry device is configured to receive an account number of a credit card or a debit card used by the user. An application database server is coupled to the pin entry device and is configured to receive a first cryptographic token from a token provider. The first cryptographic token corresponds to the account number. The first cryptographic token is used in place of the account number as a database lookup key to identify any transaction rules to be associated with the first transaction. The application database server is further configured to receive a confirmation message authorizing the first transaction, and transmit the transaction rules and confirmation message to the point of sale terminal. The point of sale terminal is further configured to initiate a second transaction for a transaction amount in response to the receipt of the transaction rules and the confirmation message.

In another embodiment, a method for conducting a withdrawal includes initiating a first transaction without a transaction amount for a user using a point of sale terminal. The method also includes receiving, by a pin entry device coupled to the point of sale terminal, an account number of a credit card or a debit card used by the user, and receiving, by an application database server coupled to the pin entry device, a first cryptographic token from a token provider. The first cryptographic token corresponds to the account number. The first cryptographic token is used in place of the account number and is used as a database lookup key to identify any transaction rules to be associated with the first transaction. A confirmation message authorizing the first transaction is received at the application database server, and the transaction rules and confirmation message are transmitted to the point of sale terminal. The point of sale terminal is further configured to initiate a second transaction for a transaction amount in response to the receipt of the transaction rules and the confirmation message.

### BRIEF DESCRIPTION OF THE DRAWINGS

Advantages of the present disclosure will be readily appreciated, as the same becomes better understood by reference to the following detailed description, when considered in connection with the accompanying drawings. Non-limiting and non-exhaustive embodiments of the present disclosure are described with reference to the following figures, wherein like numerals refer to like parts throughout the various views unless otherwise specified.

FIG. 1 is a block diagram of an example system for processing transactions.

FIG. 2 is a flowchart of an example method for initiating a first transaction as part of a two stage withdrawal process.

FIG. 3 is a flowchart of an example method for initiating a second transaction as part of the two stage withdrawal process described in FIG. 2.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment of example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system”. Furthermore, the present invention may take the form of a computer program product embodied in any tangible media or expression having computer-usable program code embodied in the media.

Any combination of one or more computer-usable or computer-readable media (or medium) may be utilized. For example, a computer-readable media may include one or more of a portable computer diskette, a hard disk, a random access memory (RAM) device, a read-only memory (ROM) device, an erasable programmable read-only memory (EPROM) or Flash memory device, a compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisional via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagram(s) in the flow diagram(s) illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart and/or block diagram block or blocks.

Several (or different) elements discussed below, and/or claimed, are described as being “coupled”, “in communication with” or “configured to be in communication with”. This terminology is intended to be non-limiting, and where appropriate, be interpreted to include without limitation, wired and wireless communication using any one or a plurality of suitable protocols, as well as communication methods that are constantly maintained, are made on a periodic basis, and/or made or initiated on an as needed basis.

The present disclosure particularly describes systems and methods for processing transactions on behalf of a customer. More specifically, a customer may wish to withdraw money from a credit or debit card account of the customer while in a location that does not have an automated teller machine or in a location that restricts access to credit withdrawals, such as a gaming establishment. The customer may initiate a two-stage withdrawal process that involves a first transaction and a second transaction linked to the first transaction. The first transaction is a token generation transaction, while the second transaction is a transaction to actually withdraw a requested transaction amount. Accordingly, the first transaction does not include a transaction amount, while the second transaction does.

The customer swipes the card or otherwise enters the personal account number (PAN) associated with the card into a pin entry device (PED) and may also enter a security code or CVC code associated with the card into the PED. The PED encrypts and transmits the PAN to a token provider server. The token provider server generates a first token (or card verification token) to be used in place of the PAN during the two-stage withdrawal process. The PAN and security code are transmitted to an acquiring bank server and to a card issuing bank server to verify the card information and to verify an associated card account status. If the card is verified, a confirmation message is transmitted back to the token provider server. In response, the token provider server transmits the token to an application database server.

The application database server queries a rule database, using the token as a lookup key, to identify any transaction rules associated with the first transaction. The application database server may then transmit a confirmation message and any identified rules to the PED and/or to a point of sale (POS) terminal associated with the PED. The customer may be prompted to add any transaction rules, such as responsible gaming limits, to his or her account or to the transaction. In addition, the customer may be prompted to enter a transaction amount for the withdrawal. The first transaction ends and the customer is prompted to insert or otherwise enter the card again into the PED to initiate the second transaction (i.e., the second stage of the withdrawal process).

In the second stage of the withdrawal process, the PAN and security code are entered into the PED and are encrypted by the PED in a similar manner as in the first transaction. The PED then transmits the PAN and security code to the token provider server which generates a second token (or transaction token) based on the PAN. The second token should match the first token if the same card is used for both the first transaction and the second transaction. The token provider server then transmits the PAN and security code to the acquiring bank server and to the card issuing bank server to verify the second transaction. If the second transaction is verified (including the transaction amount), a confirmation message is passed back to the token provider server which transmits the second token to the application database server.

The application database server compares the first and second tokens. If they match, the application database server identifies any applicable transaction rules for the second transaction and transmits the rules to the POS terminal and/or the PED for use in completing the second transaction. The second transaction is completed at the POS and/or PED, and the customer is then enabled to withdraw the funds corresponding to the requested transaction amount.

Accordingly, the methods and systems described herein provide a secure, convenient process for withdrawing funds using a customer's credit or debit card. The use of cryptographic tokens in place of the personal account number enhances the security and privacy of the transactions. If the application database server is compromised or accessed without authorization, for example, the unauthorized user would only be able to retrieve the token instead of the personal account number of the customer's card. In addition, generating separate tokens at the first and second stages enables the system to compare the tokens to verify that the same card is used in both transactions (i.e., both stages of the withdrawal process) to prevent fraud.

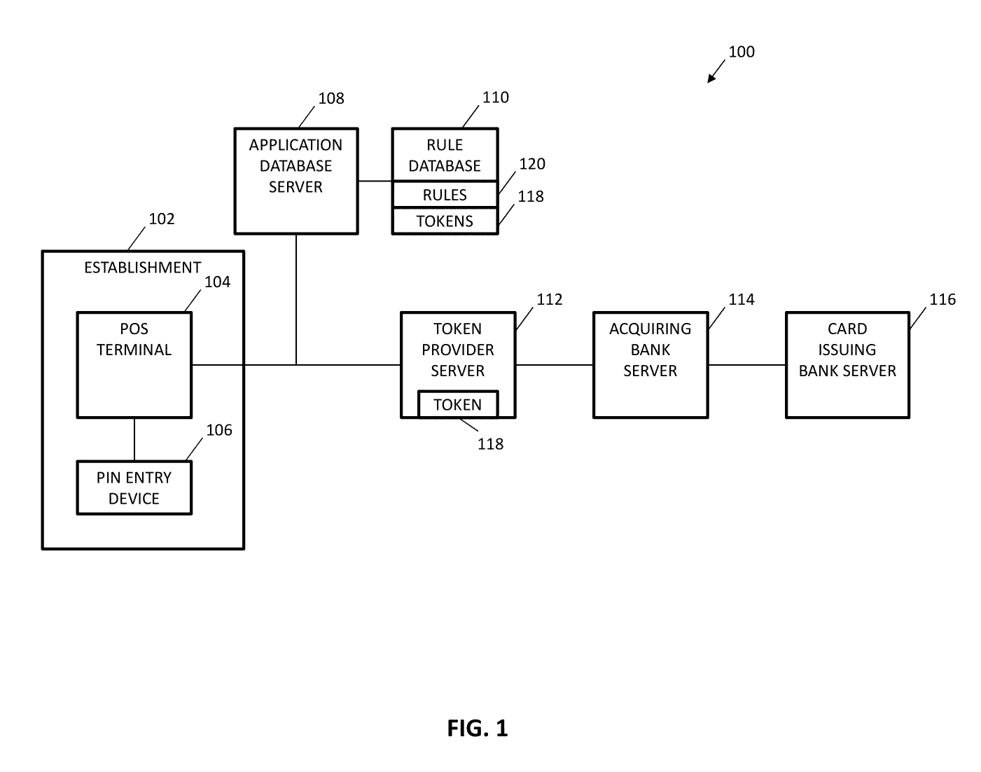

FIG. 1 is a block diagram of an exemplary system 100 for processing transactions. In an exemplary embodiment, system 100 includes an establishment 102 including one or more point of sale (POS) terminals 104 with an attached pin entry device (PED) 106. System 100 may also include an application database server 108, a rule database 110, a token provider server 112, an acquiring bank server 114, and a card issuing bank server 116. In alternative embodiments, one or more of the components of system 100 may be omitted or may be incorporated into one of the other components of system 100.

In one embodiment, establishment 102 is a casino or another gaming establishment that offers wagering games to customers. In other embodiments, establishment 102 may be a retail store, an arcade, or any other suitable establishment.

POS terminal 104 is a cashier terminal or standalone kiosk that may be used to initiate a transaction by a customer. For example, in an embodiment in which the customer is a patron of a casino, POS terminal 104 may be a standalone kiosk that the customer uses to initiate a transaction to withdraw money from a banking or credit card account of the customer for use in playing one or more casino games. Alternatively, POS terminal 104 may be a cashier terminal located within a cashier's section of the casino (sometimes referred to as a “cage”), for example.

PED 106 is a device that enables the customer to enter payment card information and other information relating to the transaction. For example, PED 106 may include a keypad or keyboard that enables credit or debit card numbers (e.g., personal account numbers and security codes) to be manually input into PED 106 by the customer or cashier. PED 106 may also include a magnetic strip reader that reads a magnetic strip of the card and extracts the PAN and security code from the strip. Alternatively, PED 106 may include a near field communication (NFC) reader that reads and extracts the PAN and security code from a chip integrated into the card using NFC technology. Still alternatively, PED 106 may receive PAN and security code using any suitable contactless technology. In addition, PED 106 may enable the customer to enter a billing zip code associated with the credit or debit card, and may enable the customer to enter any other suitable information relating to the card to initiate and complete the transaction such as an expiration date of the card. While PED 106 has been described herein as being a standalone component coupled to POS terminal 104, it should be recognized that PED 106 may be integrated within POS terminal 104 in some embodiments. The information entered into, or received by, PED 106 may be transmitted to one or more servers, such as token provider server 112, when a transaction is initiated.

Application database server 108 is a server computer that includes a processor and a computer-readable memory device that stores computer-executable instructions. In one embodiment, application database server 108 is located remotely from POS terminal 104 and PED 106 and is connected to POS terminal 104 and/or PED 106 via a wired or wireless network. Alternatively, application database server 108 is located within the same establishment 102 as POS and PED 106. Application database server 108 is also coupled to token provider server 112 by a wired or wireless network.

Rule database 110 is a database coupled to application database server 108 via a network or via another suitable data connection. In one embodiment, rule database 110 stores a plurality of data records that may be used with one or more transactions initiated by customers of the establishment 102 in which POS terminal 104 is located. Each data record may include, for example, a token 118 associated with a credit or debit card of the customer and one or more rules 120 for a transaction initiated using the credit or debit card. The data records are keyed or sorted by token 118 such that application database server 108 may query rule database 110 using token 118 as a lookup key to identify any transaction rules 120 associated with the token 118. Accordingly, in an exemplary embodiment, no PAN or other account number is stored in rule database 110 or in application database server 108. Rather, the transaction rules are keyed to a unique, anonymous token 118.

In one embodiment, transaction rules 120 may include a transaction fee to be assessed or added to a transaction amount (e.g., a withdrawal amount requested by the customer). For example, a default transaction fee may be initially set for all transactions. However, if the customer is a particularly valued customer, such as a customer having a top tier reward or loyalty status, the default transaction fee may be reduced or even waived for some or all of the transactions initiated by the customer. Transaction rules 120 may also include, for example, an authorization or denial of authorization to initiate transactions at an individual POS terminal 104 or at all POS terminals 104 within establishment 102. Thus, transaction rules 120 may identify whether or not the customer is authorized to withdraw money at one or more POS terminals 104. Transaction rules 120 may also include one or more responsible gaming limits set up by the customer or by a casino operator, for example. The responsible gaming limits may include, for example, a limit on the amount of money that the customer may withdraw from POS terminal 104 within a particular time period, such as within each hour or each day, and/or a limit on the locations or establishments 102 at which the customer may withdraw money. Some transaction rules 120 may be entered or modified by the customer (e.g., the amount of the responsible gaming limits) as described more fully herein. Other transaction rules 120 may be entered or modified by the owner or authorized representative of establishment 102 (e.g., transaction fees and whether the customer is authorized to withdraw money from POS terminal 104). Accordingly, in some embodiments, some transaction rules may be applicable to one or a subset of POS terminals 104 (such as a default transaction fee for POS terminals 104 located in casinos in which the customer is not part of the casino's reward or loyalty program), and some transaction rules may be applicable to other POS terminals 104 (such as a modified or waived transaction fees for POS terminals 104 located in casinos in which the customer is part of the casino's reward or loyalty program).

Token provider server 112 is a server computer that includes a processor and a computer-readable memory device that stores computer-executable instructions. In one embodiment, token provider server 112 is located within a data center or a payment processing center and is coupled to application database server 108, POS terminal 104, and acquiring bank server 114 via one or more networks. Token provider server 112 receives the PAN and security code, for example, from POS terminal 104 and generates a token 118 that is unique to the PAN. In one embodiment, token 118 is a multi-use or persistent alphanumeric token that is generated by applying a tokenization algorithm to PAN. The tokenization algorithm may include, for example, a cryptographic hash function that consistently generates the same output value (i.e., the token) when the same input value (i.e., the PAN) is used. Alternatively, any suitable tokenization algorithm may be used to generate token 118. Tokens 118 generated using a cryptographic tokenization algorithm are referred to herein as “cryptographic tokens”. Each token 118 may be stored and associated with the respective PAN in a card data vault (not shown) in some embodiments.

Acquiring bank server 114 is a server computer that includes a processor and a computer-readable memory device that stores computer-executable instructions. More specifically, acquiring bank server 114 is a server associated with an acquiring bank (i.e., a bank that processes payments for credit or debit card transactions initiated at POS terminal 104). For example, in one embodiment, acquiring bank server 114 may be located in the same data center or payment processing center as token provider server 112. Alternatively, acquiring bank server 114 may be located in any suitable location remote from POS terminal 104 and/or other devices or servers of system 100. Acquiring bank server 114 receives the card information from POS terminal 104, PED 106, and token provider server 112 as part of a credit or debit card transaction, and processes the requested transaction. Acquiring bank server 114 may transmit the card information and any other transaction details to card issuing bank server 116 via a payment card network, such as a network associated with Visa® or MasterCard® services.

Card issuing bank server 116 is a server computer that includes a processor and a computer-readable memory device that stores computer-executable instructions. More specifically, card issuing bank server 116 is a server associated with the bank that issued the credit or debit card to the customer. Card issuing bank server 116 maintains a credit or debit account for the customer, which is linked to the respective credit or debit card. Card issuing bank server 116 may also maintain data records indicating the status of the credit or debit account, such as whether the account is in good standing, an amount of credit or money available to the customer, whether a fraud or security alert has been issued for the account, whether the card has been reported as lost or stolen, and/or any other suitable status information relating to the customer's account or card.

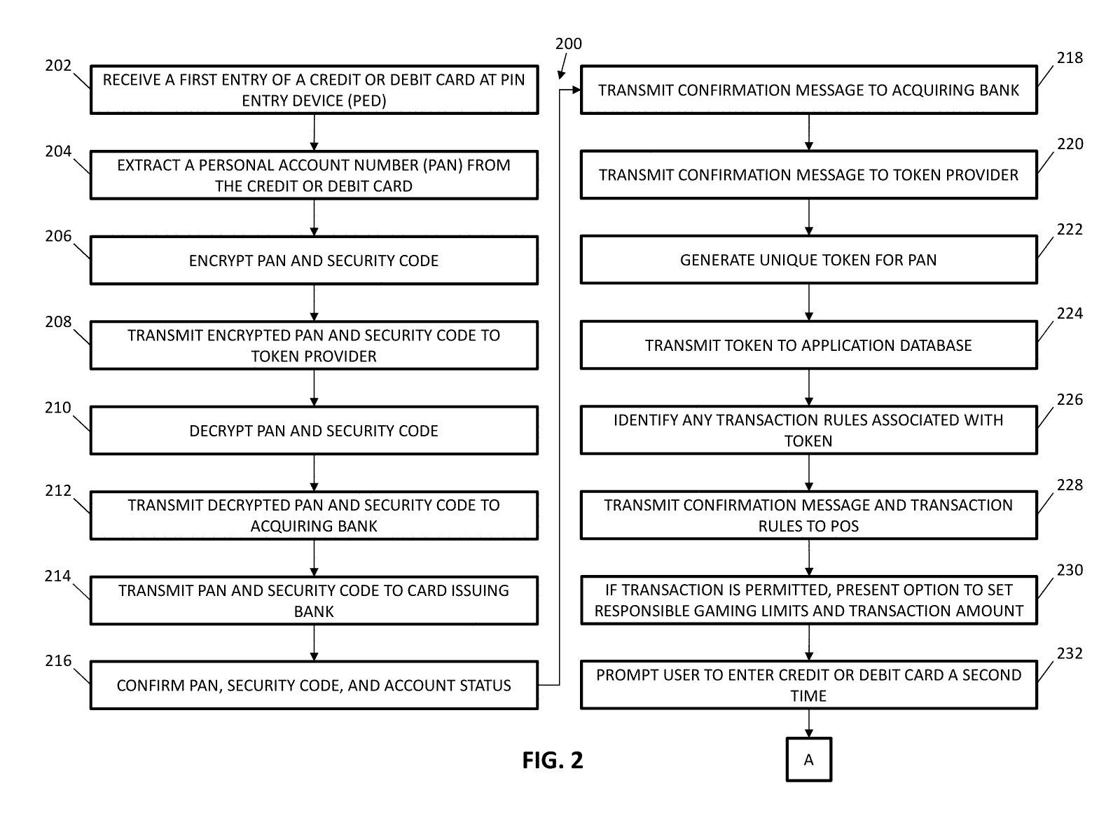

FIG. 2 is a flow diagram of an exemplary method 200 for initiating a first stage of a two-stage monetary withdrawal process. In an exemplary embodiment, method 200 is performed by the components of system 100 (shown in FIG. 1). For example, the steps of method 200 may be embodied as computer-executable instructions that are stored within one or more computer-readable media. The instructions may be executed by one or more processors to perform the steps of method 200, such as one or more processors of one or more of the POS terminal 104, PED 106, and/or servers described in system 100.

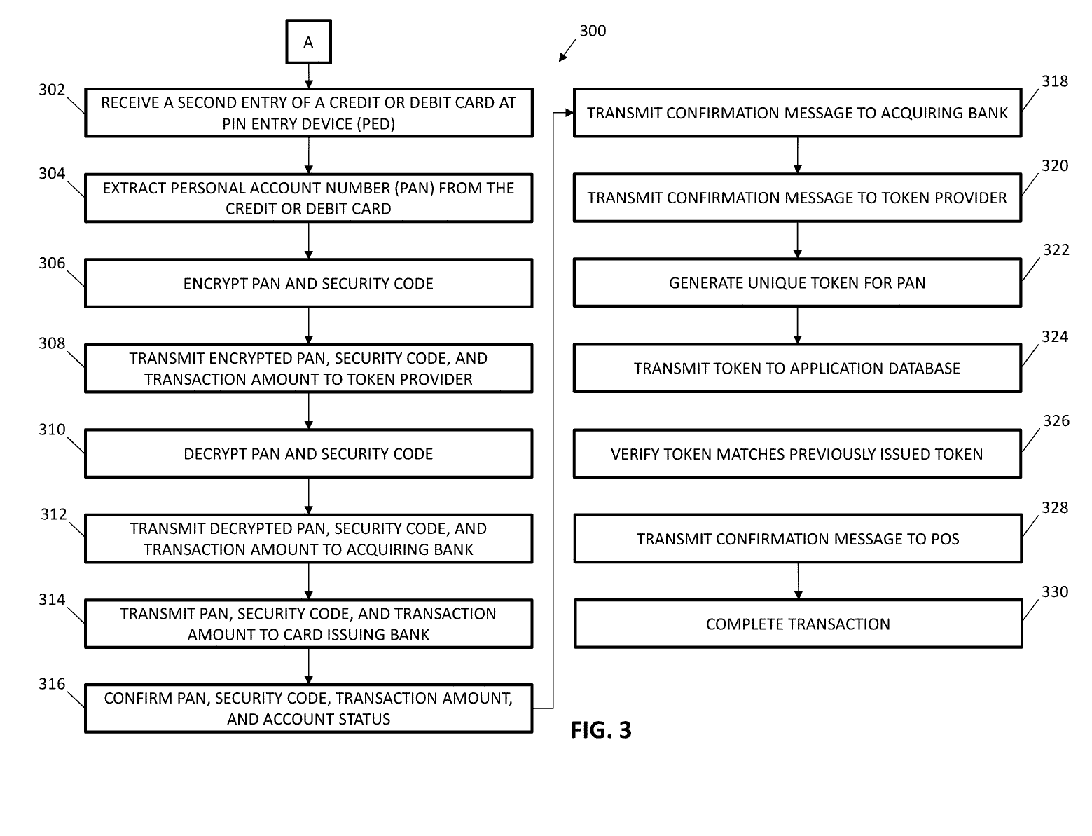

In an exemplary embodiment, method 200 may be initiated by a customer, such as a patron of a casino or other gaming establishment. The customer may initiate method 200 to withdraw money (e.g., cash) from a credit or debit account while inside the casino or gaming establishment in order to play one or more wagering games. The two-stage withdrawal process may be embodied as two separate credit or debit card transactions, in which method 200 performs the first transaction. The second transaction may be performed by method 300 (shown in FIG. 3). The first transaction may be processed as a “card not present” transaction as described more fully herein, and the second transaction may be processed as a “card present” transaction.

In one embodiment, the first stage of the withdrawal (i.e., the first transaction) and second stage of the withdrawal (i.e., the second transaction) may be initiated at different POS terminals 104 and associated PEDs 106. For example, the customer may initiate the first transaction at a standalone kiosk POS terminal 104 with an associated PED 106, and may initiate the second transaction at a cashier POS terminal 104 having an associated PED 106. Alternatively, the first and second transactions can be initiated at the same POS terminal 104 and associated PED 106.

Method 200 begins by receiving 202 a first entry of a credit or debit card at a pin entry device (PED) 106 of a point of sale (POS) terminal 104. As used herein, the entry of a credit or debit card may include any suitable means of providing credit or debit card details (such as the personal account number, security code, and any other card or customer information) to a POS terminal 104 or PED 106. For example, the credit or debit card may be “swiped” through a magnetic card reader of PED 106, may be physically inserted into a chip reader opening of PED 106, may be wirelessly read through near field communication (NFC) or another suitable wireless or contactless technology, may be manually input into PED 106 by entering the account number and security code into a keypad or keyboard of PED 106, or by any other suitable means.

The PED 106 may read and extract 204 a personal account number (PAN) from the credit or debit card. For example, PED 106 may include a magnetic strip reader that reads a magnetic strip of the card and extracts the PAN from the strip. Alternatively, PED 106 may include a NFC reader that reads and extracts the PAN from a chip integrated into the card using NFC technology. Still alternatively, PED 106 may receive the PAN using any suitable contactless technology, or may receive the PAN by the customer or a cashier manually inputting the PAN into PED 106 through a keypad or keyboard of PED 106. The customer may also enter a security code (sometimes referred to as a card verification code or CVC) for the card into PED 106 using a keyboard or a keypad, for example, of PED 106.

The PAN and security code are encrypted 206 by PED 106, and the encrypted PAN and security code are transmitted 208 to token provider server 112. In one embodiment, PED 106 may use point-to-point encryption (P2PE) to encrypt and transmit the PAN and security code to the token provider server 112.

At the token provider server 112, the PAN and security code are decrypted 210. The decrypted PAN and security code are then transmitted 212 to acquiring bank server 114. Acquiring bank server 114, in turn, transmits 214 the decrypted PAN and security code to card issuing bank server 116 for approval.

The card issuing bank server 116 confirms 216 the PAN, security code, and account status of the customer associated with the PAN. For example, the card issuing bank server 116 may determine whether the customer's account is in good standing, whether it is closed, whether the card is reported as lost or stolen, or whether there is a fraud alert associated with the account. If card issuing bank server 116 confirms 216 that the PAN and security code are valid and that the customer's account is in good standing, card issuing bank server 116 transmits 218 a confirmation message to acquiring bank server 114. In turn, acquiring bank server 114 transmits 220 the confirmation message to the token provider server 112.

In response to the receipt of the confirmation message, token provider server 112 generates 222 a token 118 that is unique to the PAN and transmits the token 118 to application database server 108. The token 118 is then transmitted 224 to application database server 108 to be used in place of the PAN. The token 118 generated in this first stage of the withdrawal process is sometimes referred to as a card validation token.

Application database server 108 identifies 226 any transaction rules 120 that are associated with the received token. For example, application database server 108 queries rule database 110 to determine whether the received token is associated with any transaction rules 120. The transaction rules 120 may include, for example, a particular transaction fee to be charged to the customer when the customer withdraws money from the account associated with the token, one or more responsible gaming limits set up by the customer or by a casino operator, whether the customer is authorized to withdraw money at that particular casino or gaming establishment, and/or any other suitable rule that is to be associated with the transaction initiated by the customer.

Once any transaction rules 120 are identified for the token 118, application database server 108 transmits 228 the confirmation message and the transaction rules to the POS terminal 104. If the transaction is permitted (based on the transaction rules and confirmation message), POS terminal 104 may present 230 the customer with an option to set or modify responsible gaming limits and an amount of money to be withdrawn during the transaction (referred to herein as the transaction amount). In another embodiment, the POS terminal 104 may present the customer with an option to set or modify one or more other transaction rules that are within the customer's control.

Once the transaction amount is set by the customer (and any applicable responsible gaming limits or other transaction rules), the customer is prompted 232 to enter the credit or debit card into PED 106 a second time. This begins a second stage of the transaction that is described in more detail in FIG. 3.

FIG. 3 is a flow diagram of an exemplary method for initiating a second stage of a two-stage monetary withdrawal process, such as the monetary withdrawal process initially described with respect to FIG. 2. In an exemplary embodiment, method 300 is performed by the components of system 100 (shown in FIG. 1). For example, the steps of method 300 may be embodied as computer-executable instructions that are stored within one or more computer-readable media. The instructions may be executed by one or more processors to perform the steps of method 300, such as one or more processors of one or more of the POS terminal 104, PED 106, and/or servers described in system 100.

The customer may initiate the second stage of the withdrawal (i.e., the second transaction) by entering the credit or debit card into the PED 106. The POS terminal 104 receives 302 the second entry of the credit or debit card and extracts 304 the PAN from the credit or debit card in a similar manner as described above. PED 106 may also receive an entry of the security code for the card by the customer. PED 106 uses the transaction amount entered by the customer at the end of the first transaction as the transaction amount for the second transaction.

In one embodiment, if the customer's credit or debit card is issued by a foreign bank or a bank having a different currency than the currency used by the acquiring bank and/or POS terminal 104, then a determination is made whether the transaction is eligible for dynamic currency conversion (DCC) as is known in the payment card industry. If the transaction is eligible for DCC, the customer may be prompted on POS terminal 104 or PED 106 to accept or decline DCC processing of the transaction. If the customer accepts DCC processing, the transaction amount will be increased by any applicable DCC processing fees. When the acquiring bank receives the transaction, the transaction will be processed in the foreign currency under DCC rules. If the customer declines DCC processing, the transaction amount will be processed in the local currency of POS terminal 104 and/or acquiring bank.

PED 106 then encrypts 306 the PAN and security code in a similar manner as described above, and transmits 308 the encrypted PAN and security code, as well as the transaction amount, to the token provider server 112. The token provider server 112 decrypts 310 the PAN and security code. The token provider server 112 then transmits 312 the decrypted PAN and security code, as well as the transaction amount, to the acquiring bank server 114. In turn, the acquiring bank server 114 transmits 314 the decrypted PAN and security code, as well as the transaction amount, to the card issuing bank server 116 for approval.

Card issuing bank server 116 confirms 316 the PAN, security code, transaction amount, and account status of the customer associated with the PAN. For example, card issuing bank server 116 may determine whether the customer's account remains in good standing, whether it is closed, or whether there is a fraud alert associated with the account. Card issuing bank server 116 may also verify that the account has sufficient funds or credit for the transaction amount requested by the customer. If card issuing bank server 116 confirms 316 that the PAN and security code are valid, the customer's account is in good standing, and that sufficient funds or credit is available for the transaction amount, card issuing bank server 116 transmits 318 a confirmation message to acquiring bank server 114. In turn, acquiring bank server 114 transmits 320 the confirmation message to the token provider server 112.

In response to the receipt of the confirmation message, token provider server 112 generates 322 a token 118 that is unique to the PAN and transmits 324 the token to application database server 108. The token 118 is used in place of the PAN during the second transaction in a similar manner as in the first transaction described above. The token 118 generated in this second stage of the withdrawal process is sometimes referred to as a transaction token. Assuming that the customer used the same credit or debit card for both the first and second transactions, the tokens 118 generated in the first and second transactions (i.e., the card validation token and the transaction token) should be identical.

If the transaction was approved by the card issuing bank server 116, application database server 108 verifies 326 that the transaction token matches the previously issued token (i.e., the card validation token). If the transaction token matches the card validation token, application database server 108 transmits 328 the confirmation message to the POS terminal 104. If the transaction is permitted (based on the confirmation message), the POS terminal 104 informs the customer that the transaction was approved and completes 330 the transaction by printing a receipt to be signed by the customer. In one embodiment, a cashier operating POS terminal 104 may request and verify the customer's identity (e.g., using a driver's license or passport) before dispensing cash in the amount of the requested withdrawal. In a further embodiment, the cashier may enter information relating to the customer's identity into application database server 108 and/or into rule database 110 via POS terminal 104 or another suitable device to correlate the customer's identity to the token 118. This information may then be used to identify or modify transaction rules relating to the customer for future transactions, for example.

However, if the tokens 118 do not match, a void message is transmitted back to the token provider server 112 to cause the transaction to be voided. The customer may also be informed of the voided transaction by a message displayed on the POS terminal 104 or a message printed by the POS terminal 104, for example.

Although specific features of various embodiments of the disclosure may be shown in some drawings and not in others, this is for convenience only. In accordance with the principles of the disclosure, any feature of a drawing or other embodiment may be referenced and/or claimed in combination with any feature of any other drawing or embodiment.

This written description uses examples to describe embodiments of the disclosure and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system, comprising:
a point of sale terminal configured to initiate a first transaction for a user, wherein the first transaction does not include a transaction amount;
a pin entry device coupled to the point of sale terminal, the pin entry device configured to receive an account number of a credit card or a debit card used by the user; and
an application database server coupled to the pin entry device, wherein the application database server is configured to:
receive a first cryptographic token from a token provider, the first cryptographic token corresponding to the account number and being used in place of the account number;
use the first cryptographic token as a database lookup key to identify any transaction rules to be associated with the first transaction;
receive a confirmation message authorizing the first transaction; and
transmit the transaction rules and confirmation message to the point of sale terminal,
wherein the point of sale terminal is further configured to initiate a second transaction for a transaction amount in response to the receipt of the transaction rules and the confirmation message.

2. The system of claim 1, further comprising receiving a second cryptographic token from the token provider in response to the initiation of the second transaction.

3. The system of claim 2, further comprising verifying that the first cryptographic token matches the second cryptographic token.

4. The system of claim 3, further comprising completing the second transaction at the point of sale terminal upon the verification that the first cryptographic token matches the second cryptographic token.

5. The system of claim 1, wherein the transaction rules include at least one rule imposing a responsible gaming limit on the second transaction.

6. The system of claim 1, wherein a default transaction fee is imposed upon the second transaction, and wherein the transaction rules include at least one rule that modifies the default transaction fee.

7. The system of claim 1, wherein the pin entry device is further configured to encrypt the account number and transmit the encrypted account number to a token provider to generate the first cryptographic token to be used in place of the account number.

8. The system of claim 1, wherein in response to receiving the confirmation message at the point of sale terminal, the point of sale terminal is configured to present an option for the user to set at least one responsible gaming limit to be used for the second transaction.

9. The system of claim 8, wherein the pin entry device is configured to enable the user to enter a transaction amount for the second transaction.

10. The system of claim 1, wherein the point of sale terminal is a first point of sale terminal of a plurality of point of sale terminals, and wherein the transaction rules include at least one transaction rule that is only applicable to the first point of sale terminal and at least one transaction rule that is applicable to each of the plurality of point of sale terminals.

11. A method for conducting a withdrawal, said method comprising:
initiating a first transaction for a user using a point of sale terminal, wherein the first transaction does not include a transaction amount;
receiving, by a pin entry device coupled to the point of sale terminal, an account number of a credit card or a debit card used by the user; and
receiving, by an application database server coupled to the pin entry device, a first cryptographic token from a token provider, the first cryptographic token corresponding to the account number and being used in place of the account number;
using the first cryptographic token as a database lookup key to identify any transaction rules to be associated with the first transaction;
receiving, at the application database server, a confirmation message authorizing the first transaction; and
transmitting the transaction rules and confirmation message to the point of sale terminal,
wherein the point of sale terminal is further configured to initiate a second transaction for a transaction amount in response to the receipt of the transaction rules and the confirmation message.

12. The method of claim 11, further comprising receiving a second cryptographic token from the token provider in response to the initiation of the second transaction.

13. The method of claim 12, further comprising verifying that the first cryptographic token matches the second cryptographic token.

14. The method of claim 13, further comprising completing the second transaction at the point of sale terminal upon the verification that the first cryptographic token matches the second cryptographic token.

15. The method of claim 11, wherein the transaction rules include at least one rule imposing a responsible gaming limit on the second transaction.

16. The method of claim 11, further comprising imposing a default transaction fee upon the second transaction, and wherein the transaction rules include at least one rule that modifies the default transaction fee.

17. The method of claim 11, further comprising encrypting, by the pin entry device, the account number and transmitting the encrypted account number to a token provider to generate the first cryptographic token to be used in place of the account number.

18. The method of claim 11, further comprising presenting, by the point of sale terminal, an option for the user to set at least one responsible gaming limit to be used for the second transaction in response to receiving the confirmation message at the point of sale terminal.

19. The method of claim 18, further comprising enabling, by the pin entry device, the user to enter a transaction amount for the second transaction.

20. The method of claim 11, wherein the point of sale terminal is a first point of sale terminal of a plurality of point of sale terminals, and wherein the transaction rules include at least one transaction rule that is only applicable to the first point of sale terminal and at least one transaction rule that is applicable to each of the plurality of point of sale terminals.
